(19) United States
(12) Patent Application Publication
(10) Pub. No.: US 2004/0121159 A1
(43) Pub. Date: Jun. 24, 2004

(54) Microtome blade coating for enhanced performance

(76) Inventors: Nathan Cloud, Wilmington, DE (US); Christopher J. Tarsa, Lebanon, PA (US); Leon F. Tarsa, Lebanon, PA (US)

Correspondence Address: Amy A. Ostrom, Ph.D., Akerman Senterfitt, Suite 400, 222 Lakeview Avenue, West Palm Beach, FL, 33402-3188, US

(21) Appl. No.: 10/704,441

(22) Filed: Nov. 7, 2003

Related U.S. Application Data
(60) Provisional application No. 60/425,205, filed on Nov. 8, 2002.

(51) Int. Cl. B26B 21/14

(52) U.S. Cl. 428/421; 30/62

(57) ABSTRACT

A composite coating for knife blades, particularly microtome blades and the process for achieving the coating.

### CROSS-REFERENCE TO RELATED APPLICATIONS

This application claims the benefit of U.S. Provisional Application No. 60/425,205, filed in the United States Patent and Trademark Office on Nov. 8, 2002, the entirety of which is incorporated herein by reference.

### FIELD OF THE INVENTION

The invention relates generally to the fields of histology and medical devices. More particularly, the invention relates to coated microtome blades.

### BACKGROUND

Sharp knives are important to many professions, including histology professionals. Microtome knife blades must be extremely sharp to be useful by histology professionals to cut very thin samples of human, animal, and plant tissue, as well as inanimate materials.

A number of references disclose methods of treating cutting edges. For example, U.S. Pat. No. 5,985,459 is directed to a method of treating razor blade cutting edges. A polyfluorocarbon coating on the blade is put in place by first forming a dispersion of the polyfluorocarbon, which is then sprayed onto the cutting edge. The fluorocarbon polymers may be selected from a group of polymers that include tetrofluoroethylene, but which may include copolymers such as those with a minor proportion of hexifluoropropylene.

U.S. Pat. No. 3,518,110 also discloses a razor blade and method of making such blade. A method is provided that is used to improve the shaving characteristics of razor blades by applying adhering coatings to the cutting edges. The coatings are fluorocarbon polymers.

U.S. Pat. No. 3,911,579 is directed to cutting instruments generally, and the methods of making such instruments. The cutting edge is formed by sputter deposited refractory material that is subsequently overlayed with a coating material. The refractory material may include boron nitride.

U.S. Pat. No. 5,897,751 discloses a method of fabricating boron containing coatings. The coatings may include a layer of boron nitride.

U.S. Pat. No. 5,783,308 discloses a ceramic reinforced fluoropolymer for use as a coating. The fluoropolymer includes a particulate fluoropolymer and a particulate boron nitride. The coating is said to effectively reduce friction in mechanical test apparatus.

None of the disclosures are capable of producing the results that the process of the subject application can accomplish, particularly with respect to the production of microtome blades.

### SUMMARY OF THE INVENTION

Accordingly, it is an object of the subject invention to develop a process for microtome knife blades that achieves an optimum balance of blade tip and edge properties.

It is a further object of the subject invention to provide a coating and a process for microtome knife blades which will result in a high marketplace performance, but yet at a low production cost.

It is still another object of the present invention to improve performance of a knife blade that is particularly suited for use as a microtome knife wherein characteristics of cut feel, compression, slide clarity, and life of the blade are all generally improved over other blades on the market today.

It is but another object of the present invention to produce a knife wherein the cut feels effortless and smooth to the trained histologist.

It is still another object of the subject invention to minimize compression as a characteristic of a knife blade.

It is yet another object of the subject invention to enhance the edge definition and utilize a knife tip that is sufficiently smooth that imperfections do not occur in the cut sample slides when the knife is used by a histologist.

It is but one more object of the subject invention to provide a microtome knife blade wherein the capacity of the edge and tip to resist wear are greatly enhanced.

It is a related object of the subject invention through blade edged durability to improve upon the number of cuts that can be performed, thus improving blade life.

In accordance with the objects of the subject invention, a first layer of a composite coating is placed on the stainless steel blade, the composite coating being titanium nitride, aluminum titanium nitride, or an amorphous diamond-like coating (DLC) which is formed on the knife tip and edge, as for example, by a physical vapor deposition process. The coating increases the blade edge definition and durability, and creates a smooth but compatible surface for bonding of a subsequent layer of the composite coating.

The second layer of the coating composite is an amorphous fluoropolymer or copolymer in the family of PATE polymers, such as Teflon AF by Dupont (Wilmington, Del.). This copolymer structure is soluble in perfluorinated solvents such as 3M's (Maplewood, Minn.) FC family of perfluorinated solvents, which allows the polymer to be substantially diluted and applied over the ceramic coating layer by direct immersion in the solution.

In the case of microtome blades, the application of the composite coating can be made when the blades are placed side by side in a metal frame, which may be designed to hold 1,000 or more blades in such manner. For the first coating layer (e.g., ceramic coating), the blades are placed in a vacuum chamber in which metals are sublimated into a vapor. The three steps in this vapor deposition process are heating, conditioning, and coating.

Once the blades are removed from the physical vapor deposition (PVD) chamber, they are cooled and cleaned, after which the PDD-TFE copolymer diluted in perfluorinated solvent is applied to the blade tips, preferably by dipping.

After the diluted polymer solution is applied, the blades are placed in an oven in order to rapidly evaporate the perfluorinated solvent and leave behind the ultra-thin polymer coating.

The ultra-thin composite coating thus produced on the blade tips provides the microtome blade with a combination of low slice compression, excellent user “cut feel”, excellent slide clarity, and long blade life.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control. The particular embodiments discussed below are illustrative only and not intended to be limiting.

### DETAILED DESCRIPTION OF DRAWINGS

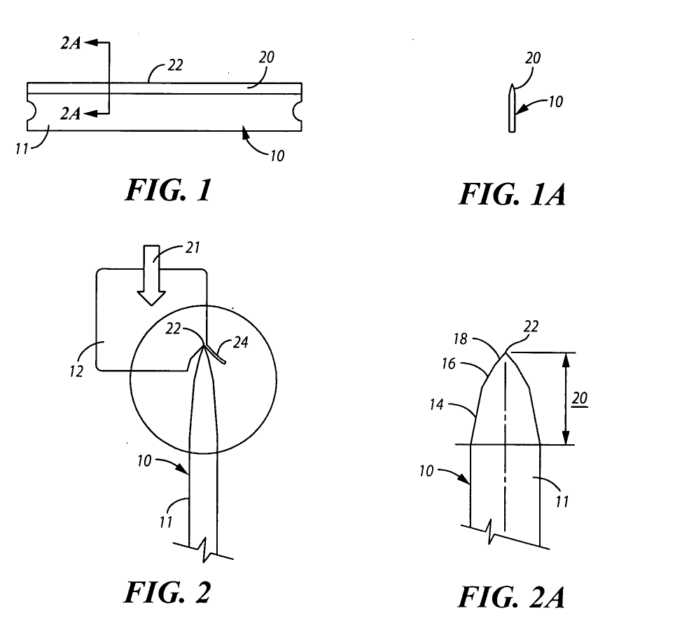

FIG. 1 is a plan view of microtome knife blade;

FIG. 1A is an end view of the microtome blade of FIG. 1;

FIG. 2 is a side view of a microtome blade shown slicing into a biopsy specimen block;

FIG. 2A is an enlarged side view of the blade of FIG. 2;

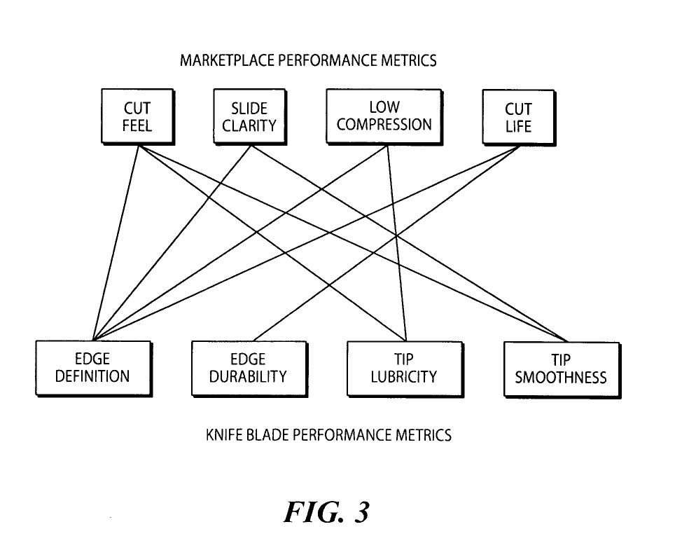

FIG. 3 is a block diagram setting forth knife blade performance metrics as related to marketplace performance metrics;

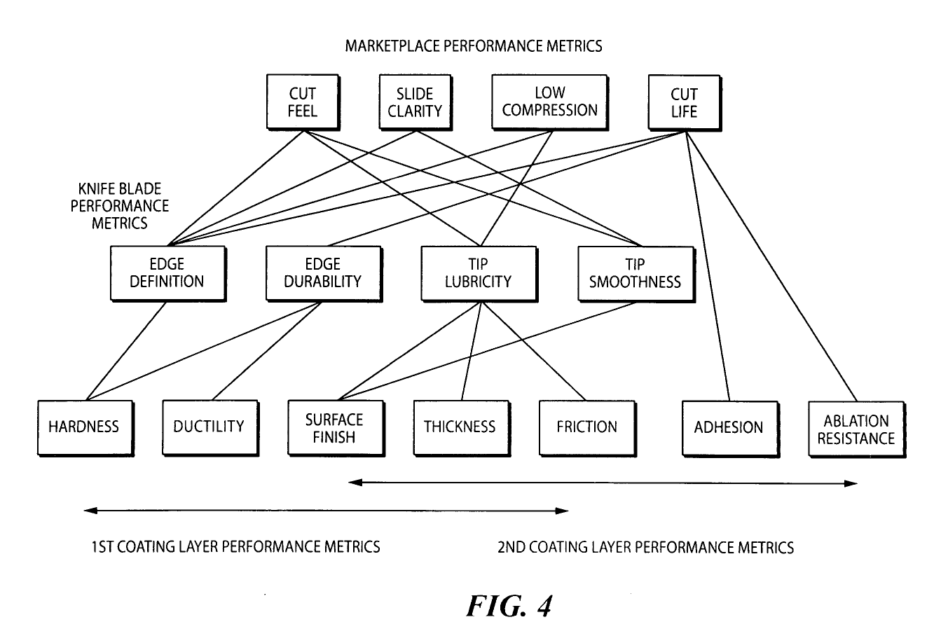

FIG. 4 shows the diagram of FIG. 3 as affected by the two layers of the coating composite;

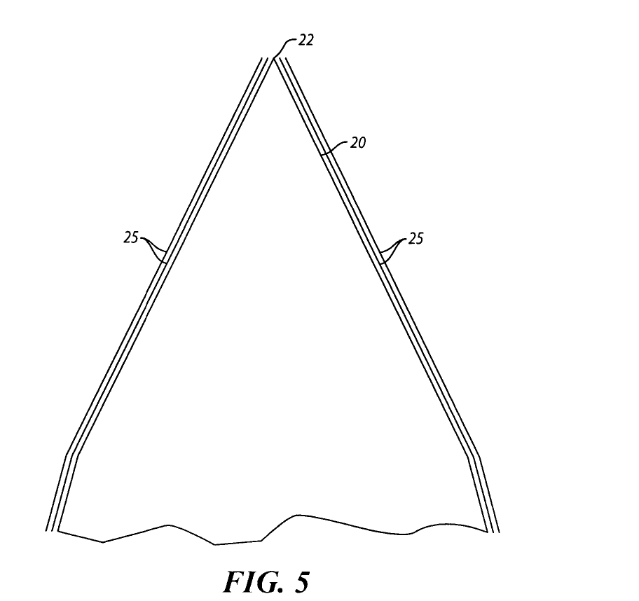

FIG. 5 is a diagram which provides a perspective of the thickness of the coating composite;

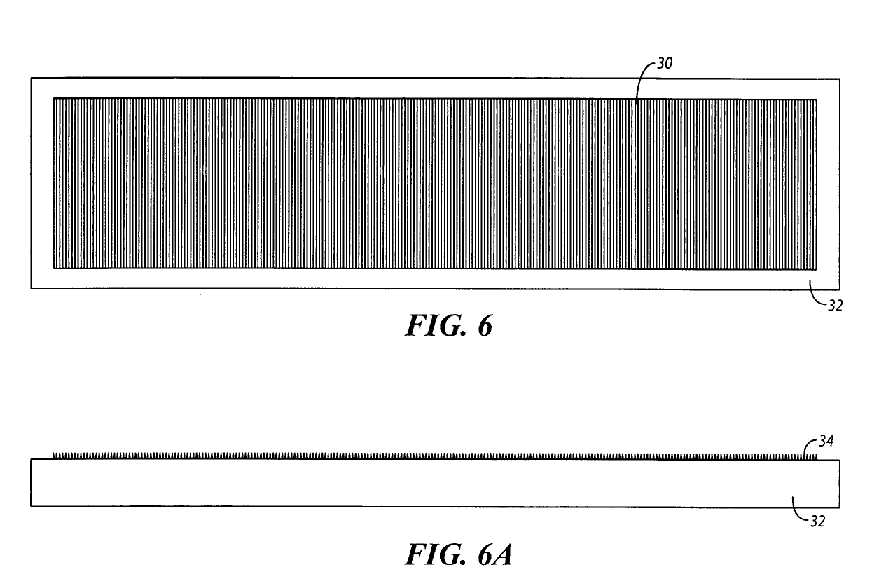

FIG. 6 is a top view of a blade frame fixture looking down at tips of blades held side by side in the fixture;

FIG. 6A is a side view of the fixture of FIG. 6 showing the blade tips extending upwardly past the edge of the fixture;

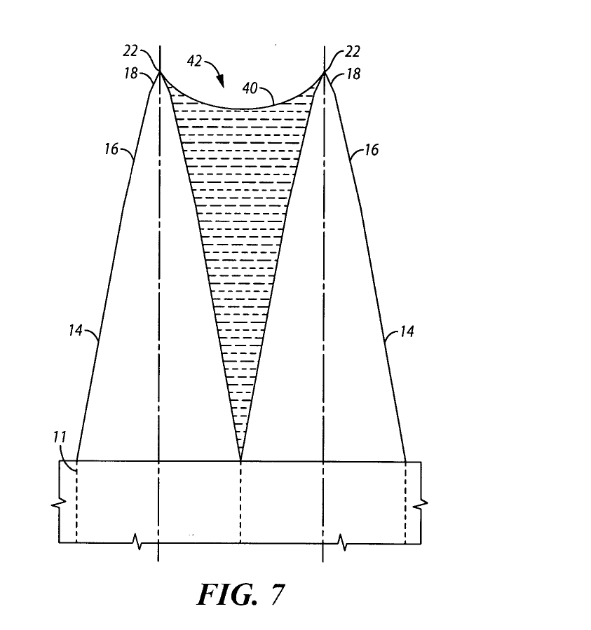

FIG. 7 shows two microtome blades side by side as the composite coating is applied.

### DETAILED DESCRIPTION

The below described preferred embodiments illustrate adaptations of these compositions and methods. Nonetheless, from the description of these embodiments, other aspects of the invention can be made and/or practiced based on the description provided below.

The preferred embodiment of the invention is shown in FIG. 1, featuring microtome blade 10. The microtome knife blade 10 is to be mounted in a typical microtome cutting machine (not shown). It is used with a specimen sample (“block”12 as shown in FIG. 2. The blade 10 is of typical shape for microtome blades with tip 20 having cutting edge 22. Typical thickness of a blade 10 is 0.25 mm. The blade 10 has a relatively straight portion 11 and several beveled portions 14, 16, 18 forming the cutting edge. Multiple tissue slices are produced from the specimen block 12 when the histologist operates the microtome, moving the block 12 down past the stationary blade 10 in a guillotine action.

A series of bevels 14, 16, 18, are present on each side of the blade 10 to form the microtome blade “tip” 20 (FIG. 2A). As shown in FIG. 2, during the cutting action, the blade edge 22 cuts through the tissue sample, and the tip contacts the tissue slice 24 on one side, and the tissue block 12 on the other side. Arrow 21 shows the direction of the movement of the tissue block 12 past the microtome blade 10.

While the discussion, past and future, follows the preferred embodiment of a microtome blade, it must be recognized that the teachings herein can be applied to other types of blades as well.

In practice, slides are made from the tissue specimen slices 24, and are examined under a microscope for cellular abnormalities by a Pathologist. The performance of the blades, and hence their attractiveness in the marketplace, is determined by the following metrics; “cut feel”, “compression”, “slide clarity”, and “life”. These metrics are defined in the following way:

Cut Feel: The feel that a histologist has for the fineness and ease of cut as he/she operates the microtome machine.

Compression: The distance a specimen sample slice is compressed from its original dimension by the cutting action.

Slide Clarity: The clarity, or absence of defects, i.e. striations, that a specimen slice has when mounted and stained on a glass slide used in microscopic examination.

Life: The number of cuts that a histologist can make with a knife in a microtome, before the aggregate of the above performance attributes falls below a certain level, based on the judgment and discretion of a given histologist.

The above performance metrics are weighed collectively against cost in ultimately determining their value in the histology marketplace.

Microtome blade properties that affect the above performance metrics are: Edge “definition” (generally called “sharpness” by the general public when describing a knife blade edge), durability; tip lubricity and smoothness. These attribute metrics and their relationship to histology marketplace metrics are shown in FIG. 3.

Thus “Cut Feel” relates to “Edge Definition”, “Tip Lubricity” and “Tip Smoothness”. The “Slide Clarity” relates to “Edge Definition” and “Tip Smoothness”. “Low Compression” relates to “Edge Definition” and “Tip Lubricity”. “Cut Life” relates to “Edge Definition” and “Edge Durability”.

Additional details of these metrics-are provided as follows.

Edge definition: The degree to which a cutting blade can be machined to a precise and distinct point, as viewed in cross section; and the degree to which this point is maintained as a precise line across the full length of the blade edge when viewed microscopically. Poor edge definition causes high compression and sample slide striations.

Edge durability: The degree to which the cutting edge maintains it's “definition” with use over time. “Durability” is a combination of hardness and toughness.

Tip lubricity: The frictional characteristics of the blade tip, which is experienced by the ease with which the blade is moved through a specimen block to cut a sample slice. i.e.; materials with a low coefficient of friction usually exhibit “lubricity”: depending to some degree on the relative characteristics of the surfaces they are sliding against.

Tip smoothness: The absence of surface imperfections that could cause marks on tissue specimens during cutting.

Plain (uncoated) microtome blades are made of stainless steel, which is machined to produce an edge, and tip geometry that has proven over time to result in good cutting performance. Typical performance metrics for plain steel blades are:

| | |
|---|---|
| Cut Feel | 7.0* |
| Compression | 6.0* |
| Slide Clarity | 8.0* |
| Life | 100-400 cuts |

(The source of the above values is registered histologist evaluation. *scale of 1-10, where 10 is current technology best)

A coating imparted to the plain steel knife blade can substantially improve the values of these performance metrics, and thus improve marketplace value.

The present invention includes both the composite coating for the blades, as well as a production process for producing microtome knife blades that achieves an optimum balance of blade tip and edge properties, resulting in high marketplace performance at low production cost.

The first layer of the composite coating on the stainless steel blade is a thin carbon or ceramic coating which can be an amorphous DLC, titanium nitride (TiN) or Aluminum titanium nitride (AlTiN), which is formed on the knife tip and edge, for example, by a PVD process. Any suitable deposition process may be used for coating a blade, e.g., ultrasonic spraying, air jet atomized spraying, dipping, blotting, brushing. This coating increases the blade edge definition and durability, and creates a smooth but compatible surface for tenacious bonding of the subsequent layer of the composite coating. It can also be formed in a sufficiently thin layer that it negligibly changes the cross section geometry of the blade edge at tip. Relevant performance metrics and typical values for this layer are:

| | |
|---|---|
| Hardness (HV .05) | 3000-5000 |
| Ductility (%) | ˜1.0 |
| Surface finish (Ra um) | 0.15-0.20 |
| Thickness | ≦.02 microns |

The second layer of the coating composite is an amorphous fluoropolymer, or copolymer, in the family of PTFE polymers, such as Dupont's Teflon AF the monomer components of the copolymer are PDD and TFE (perfluoro(2,2-dimethyl-1,3-dioxole), and tetrafluoroethylene). This copolymer structure is soluble in perfluorinated solvents such as 3M's FC family of perfluorinated solvents. This allows the polymer to be substantially diluted, and applied over the ceramic coating layer by direct immersion in the solution. Subsequent evaporation of the solvent under elevated temperature leaves the polymer mechanically bonded to the substrate. Relevant performance metrics that apply for this coating layer are:

| | |
|---|---|
| Surface Finish | Excellent - conformal to substrate* |
| Thickness - | ≦0.1 micron |
| Friction | ˜.2 (coeff of friction) |
| Adhesion | Excellent * |
| Ablation resistance | Excellent * |

The cause-effect relationship the above metrics, for both layers of the coating composite, have to the blade performance metrics is shown in FIG. 4.

Microtome knives with an amorphous fluoropolymer coating over a ceramic nitride coating exhibit the following improved performance metrics.

| | |
|---|---|
| Cut Feel | 10.0 |
| Compression | 10.0 |
| Slide Clarity | 10.0 |
| Life | 600-1000 cuts |

(The source of the above values is registered histologist evaluation. *scale of 1-10, where 10 is current technology best)

These performance enhancements are achieved because the coating layers provide a unique combination of attributes (FIG. 4).

With reference to FIG. 5, the combined thickness of the two layers (<0.2 microns) negligibly increase the geometric profile (cross section) of the cutting tip/edge, which along with the lubricious fluoropolymer coating allows the blade to easily slip through the specimen sample. Consequently the cut “feels” effortless and smooth to the trained histologist. Also, “compression” is minimized—in some tests it has been zero. FIG. 5 provides a scale perspective of the thinness of the coating composite. The composite coating layers 25 are 0.2 micron thick. As shown layers 25 are shown approximately scaled to knife substrate geometry and raised from surface for clarity.

Further, the edge “definition” is enhanced, and the tip is sufficiently smooth such that imperfections in the cut sample slides are minimal to zero. Finally, the capacity of the edge and tip to resist wear (performance property degradation) are greatly enhanced. Not only is the blade edge durability enhanced by the ceramic layer, but the thin polymer layer adheres well to the ceramic layer on the blade tip, because the energy level and microscopic topography of the two materials are compatible. The result is that the number of cuts that can be performed (ie; blade “life”is increased substantially.

In order to facilitate low cost handling and application of the composite coating, multiple microtome blades 30 (FIG. 6) are placed side by side in a metal frame (fixture) 32 with blade tips 34 extending past the side face of the fixture 32 as shown in FIG. 6A. A single such fixture 32 may hold more than 1,000 blades in such a manner.

For the first coating layer (ceramic), multiple fixtures 32 loaded with blades 30 are placed in a Vacuum chamber in which metal nitrides are sublimated (evaporated) into a vapor, and ionized with multiple arc sources located on the vacuum chamber walls. The plasma cloud of highly active and excited coating material forms an ultra thin coating when it is condensed onto the tips of the microtome blades 30 that extend past the face of the fixture 32. The three steps in this PVD process are: heating, conditioning, and coating. In the heating step, surface contamination is cleaned thermally and chemically. Thermal cleaning is achieved radiantly or through ion bombardment otherwise known as sputtering. During the heating step, the temperature of the fixtured blades is raised to a temperature in the range of about 200° C.-500° C. Chemical cleaning can be achieved through the introduction of hydrogen. The blades 30 are conditioned when several chamber evaporators are activated briefly and high voltage is applied to the fixtured blades. This conditioning step enhances coating adhesion by producing a thin mixed layer at the blade surface. Finally, the deposition reaction is achieved when the remaining evaporators are activated, the desired voltage is achieved and the appropriate gases are introduced to produce the desired coating (e.g., ceramic, carbon coating).

After the fixtured blades are removed from the PVD chamber, they are cooled, and then cleaned with a jet of anhydrous (<1% by volume H₂O) Isopropyl alcohol (IPA).

As an alternative embodiment, instead of a ceramic coating, a carbon coating may be used, such as amorphous DLC or PVD diamond coating. A PVD process is used similar to that described above which produces the ceramic coating.

Following this cleaning step, and after the IPA has evaporated, the PDD-TFE copolymer, diluted in Perfluorinated solvent (to 0.2-0.7% by volume polymer solids) is applied to the blade tips, by dipping the tips into a shallow layer of the coating solution. The solution is metered into a dip pan, which is designed in such a way that when the blade fixture is lowered onto it, only the blade tips are immersed in the solution. The fixtured blades are then removed from the solution, and excess solution is allowed to run back into the pan. The blade fixture is then inverted so that the blade edges are pointing up. The coating solution fills the valleys formed by the extended tips 34 of the blades held in a fixture 32 as shown in FIG. 6. Each successive fixture 32 with blades 30 is placed on the dip pan, and just enough coating solution is metered into the pan to return the surface of the solution to the required level—tips immersed. This coating method ensures that a minimum, but essential, amount of coating solution is applied to the blades, contributing to the cost effectiveness of the process.

Immediately after the diluted polymer solution is applied to the grouped blades the fixture 32 is placed into an oven at an elevated temperature greater than the glass transition temperature (Tg) (e.g., greater than 160° C.) in order to rapidly evaporate the perfluorinated solvent, and leave behind a continuous layer of the ultra thin polymer coating. As seen in FIG. 7, the meniscus 40 that forms at the top of the blade valleys 42 prior to placing the fixture in the drying oven causes the polymer solids that form on the blade tips to be thinnest at the edge end of the blade tips—further supporting the blade performance enhancement resulting from the coating.

The relative amount of monomer in the copolymer may be varied to achieve a more optimum combination of cutting performance metrics for certain histology applications. The drying temperature in the oven should be over the Tg so that the polymer solids “flow” to produce a uniform, smooth surface on the blade tip 20.

The ultra thin composite coating thus produced on the blade tips 20 imparts to the microtome blade an optimum combination of: low slice compression, excellent user “cut feel”, excellent slide clarity and long blade life, at low processing cost.

Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A blade comprised of:
a first coating selected from the group consisting of: ceramic, nitride, and diamond-like coating; and
a second coating from the family of PTFE polymers.

2. The blade of claim 1 wherein the first coating is titanium nitride.

3. The blade of claim 1 wherein the first coating is aluminum titanium nitride.

4. The blade of claim 1 wherein the first coating is an amorphous diamond-like coating.

5. The blade of claim 1 wherein said blade is a microtome blade.

6. The blade of claim 5 wherein said blade is manufactured together with multiple other blades placed side by side in a fixture for dipping.

7. A microtome blade comprised of a coating selected from the group consisting of: ceramic, nitride, and diamond-like coating.

8. The microtome blade of claim 7 wherein the coating is titanium nitride.

9. The microtome blade of claim 7 wherein the coating is aluminum titanium nitride.

10. The microtome blade of claim 7 wherein the coating is an amorphous diamond-like coating.

11. A microtome blade comprised of a coating from the family of PTFE, polymers.

12. A process for coating a blade comprising the steps of:
placing the blade in a vacuum chamber in which metal nitrides are sublimated into a vapor;
subjecting the blade to heat;
conditioning the blade after heating;
admitting gas to the chamber to produce a ceramic coating;
removing the blade from the vacuum chamber;
applying PDD-TFE copolymer diluted in perfluorinated solvent to the blade; and
evaporating the perfluorinated solvent.

13. The process of claim 12 wherein multiple blades are placed side by side in a fixture with the blade tips extending past the side face of the fixture comprising the further steps of:
during the application of the perfluorinated solvent, lowering the blades within the fixture into the dip pan so that only blade tips are immersed in the solution; and
inverting the fixture after removal from the solution so that the blade tips are pointing upwardly to enable the coating solution to fill valleys formed by the extended tips of the blades.

14. The process of claim 12 wherein the metal nitrides are ionized with multiple arc sources located on the vacuum chamber walls.

15. The process of claim 12 wherein the blade is subjected to heat by radiant heaters to remove absorbed contamination from the blade.

16. The process of claim 12 wherein the blade is subjected to heat by ion bombardment to remove absorbed contamination from the blade.

17. The process of claim 12 wherein the temperature of the blade is raised to a temperature in the range of about 200 degrees centigrade to about 500 degrees centigrade.

18. The process of claim 12 wherein the step of conditioning the blade after heating occurs by activating evaporation sources at high voltage.

19. The process of claim 18 wherein the activating evaporation sources at high voltage produces a mixed layer at the surface of the blade.

20. The process of claim 19 wherein the mixed layer at the surface of the blade leads to enhanced adhesion of the coating.

21. The process of claim 12 wherein the step of admitting gas simultaneously involves the step of activating all evaporation sources and reducing voltage.

22. The process of claim 12 further comprising the step of cooling the blade after the blade is removed from the vacuum chamber.

23. The process of claim 12 further comprising the step of cleaning the blade after the blade is removed from the vacuum chamber.

24. The process of claim 12 further comprising the step of cooling and then cleaning the blade with a jet of anhydrous isopropyl alcohol after the blade is removed from the vacuum chamber.

25. The process of claim 12 wherein the step of applying PDD-TFE copolymer further comprises the step of dipping the blade tip into a solution of PDD-TFE copolymer diluted in perfluorinated solvent.

26. The process of claim 12 wherein evaporating the perfluorinated solvent comprises the step of placing the blade into an oven above the-copolymer glass transition point in order to rapidly evaporate the perfluorinated solvent.

27. The process of claim 26 wherein the blade tip comprises an ultra-thin polymer coating after evaporation of the perfluorinated solvent.

28. A microtome blade made by the process of claim 12.

29. A process for coating a blade comprising the steps of:
placing the blade in a vacuum chamber in which amorphous DLC is sublimated into a vapor;
subjecting the blade to heat;
conditioning the blade after heating;
admitting gas to the chamber to produce a carbon coating;
removing the blade from the vacuum chamber;
applying PDD-TFE copolymer diluted in perfluorinated solvent to the blade; and
evaporating the perfluorinated solvent.
